(19) United States
(12) Patent Application Publication
(10) Pub. No.: US 2025/0179276 A1
(43) Pub. Date: Jun. 5, 2025

(54) TIRE RUBBER COMPOSITION

(71) Applicant: The Yokohama Rubber Co., LTD., Kanagawa (JP)

(72) Inventors: Kaori OSUMI, Kanagawa (JP); Ryutaro NAKAGAWA, Kanagawa (JP); Kentaro TAKEUCHI, Kanagawa (JP)

(21) Appl. No.: 18/846,150

(22) PCT Filed: Mar. 14, 2023
(86) PCT No.: PCT/JP2023/009844

§ 371 Date: Sep. 11, 2024

(30) Foreign Application Priority Data
Mar. 16, 2022 (JP) 2022-041019

(51) Int. Cl. C08L 9/06; B60C 1/00; C08K 3/36

(52) U.S. Cl. CPC C08L 9/06; B60C 1/0016; C08K 3/36

(57) ABSTRACT

To provide a rubber composition for a tire capable of achieving improved snow performance, wet performance and wear resistance performance in a highly balanced manner. For a rubber composition for a tire, containing: 100 parts by mass of a diene rubber containing 55 mass % or more of a styrene-butadiene copolymer whose glass transition temperature is −55° C. or lower and 5 mass % or more of a butadiene copolymer; 30 parts by mass or more and less than 100 parts by mass of a white filler; and 15 parts by mass or more and 80 parts by mass or less of a thermoplastic resin, a difference Tga−Tgm between Tga and Tgm is set to 10° C. or less, where Tga is a theoretical glass transition temperature of a mixture in which the diene rubber and the thermoplastic resin are blended at a mass ratio of 1:1.

### TECHNICAL FIELD

The present technology relates to a rubber composition for a tire intended to be used mainly in a tread portion of a winter tire or an all-season tire.

### BACKGROUND ART

Tires assumed to be used on snow-covered road surfaces (winter tires and all-season tires) are required to have excellent running performance on snow-covered road surfaces (snow performance). The tire is also required to have, as basic performance, excellent running performance on wet road surfaces (wet performance) and wear resistance performance. For example, Japan Patent No. 6888948 B proposes a tire in which silica and various resin components are blended in a styrene-butadiene rubber having a low glass transition temperature, with performance at normal temperature, such as wet performance, being improved while a decrease in low-temperature performance is suppressed.

However, in recent years, the performance required of tires has increased, and it cannot necessarily be said that the above-described measures alone are sufficient. For this reason, there is a demand for measures for achieving the snow performance, the wet performance, and the wear resistance performance in a more highly balanced manner in the rubber composition for a tire.

### SUMMARY

The present technology provides a rubber composition for a tire capable of achieving improved snow performance, wet performance and wear resistance performance in a highly balanced manner.

A rubber composition for a tire of the present technology contains: 100 parts by mass of a diene rubber containing 55 mass % or more of a styrene-butadiene copolymer whose glass transition temperature is −55° C. or lower and 5 mass % or more of a butadiene copolymer; 30 parts by mass or more and less than 100 parts by mass of a white filler; and 15 parts by mass or more and 80 parts by mass or less of a thermoplastic resin, the rubber composition for a tire satisfying a difference Tga-Tgm between Tga and Tgm of 10° C. or less, where Tga is a theoretical glass transition temperature of a mixture in which the diene rubber and the thermoplastic resin are blended at a mass ratio of 1:1, the theoretical glass transition temperature Tga being calculated from glass transition temperatures of the diene rubber and the thermoplastic resin, and Tgm is a measured glass transition temperature of the mixture.

The rubber composition for a tire of the present technology contains a specific thermoplastic resin and a white filler which are blended in a diene rubber containing a styrene-butadiene copolymer having a specific glass transition temperature and a predetermined amount of a butadiene copolymer, and thus can have improved snow performance, wet performance, and wear resistance performance.

In the present technology, a total amount of the oil contained in the rubber composition for a tire is preferably less than 25 parts by mass per 100 parts by mass of the diene rubber. This is advantageous for improving the snow performance.

In the present technology, the styrene-butadiene copolymer preferably has a glass transition temperature of −64° C. or lower. Further, at least one terminal of the styrene-butadiene copolymer is preferably modified with a functional group. This is advantageous for improving the snow performance and the wet performance.

In the present technology, the thermoplastic resin preferably has a glass transition temperature of from 40° C. to 120° C. Also, the thermoplastic resin is preferably at least one selected from the group consisting of resins composed of at least one selected from terpenes, modified terpenes, rosins, rosin esters, C5 components, and C9 components, and resins in which at least some of double bonds of these resins are hydrogenated.

In the present technology, an oil extension amount of the styrene-butadiene copolymer is preferably 10 parts by mass or less per 100 parts by mass of the styrene-butadiene copolymer. This is advantageous for improving the wear resistance.

In the present technology, a maximum value tan δ_{MAXA} of a loss tangent at from −40° C. to 60° C. of the rubber composition for a tire and a maximum value tan δ_{MAXB} of a loss tangent at from −40° C. to 60° C. of a rubber composition B having the same composition as that of the rubber composition for a tire except that all the thermoplastic resin is replaced with oil preferably satisfy Formula (1) below in relation to the rubber composition B:

tan δ_{MAXA}/tan δ_{MAXB}>0.8 (1)

The rubber composition for a tire described above can be used suitably for a tread portion of a winter tire or an all-season tire. A tire having a tread portion containing the rubber composition for a tire described above can satisfactorily exhibit snow performance, wet performance, and wear resistance performance due to the excellent physical properties of the rubber composition for a tire described above. The tire in which the rubber composition for a tire of the present technology is used is preferably a pneumatic tire, but may be a non-pneumatic tire. In the case of a pneumatic tire, the interior thereof may be filled with air, an inert gas such as nitrogen, or another gas.

### DETAILED DESCRIPTION

A rubber component constituting the rubber composition for a tire according to an embodiment of the present technology is a diene rubber, and 55 mass % or more of a styrene-butadiene copolymer having a glass transition temperature (hereinafter sometimes referred to as “Tg”) of −55° C. or lower is necessarily contained in 100 mass % of the diene rubber. Blending of the styrene-butadiene copolymer having a Tg of −55° C. or lower can make dispersibility of the silica good and ensure wear resistance and wet performance. The amount of the styrene-butadiene copolymer having a Tg of −55° C. or lower is 55 mass % or more, preferably from 55 mass % to 80 mass %, and more preferably from 60 mass % to 75 mass %, in 100 mass % of the diene rubber. When the amount of the styrene-butadiene copolymer is less than 55 mass %, an effect of enhancing dispersibility of the silica cannot be adequately achieved, and the wet performance deteriorates.

When the Tg of the styrene-butadiene copolymer is higher than −55° C., the wet performance cannot be sufficiently ensured. The Tg is preferably −64° C. or lower, more preferably from −65° C. or lower, and even more preferably from −70° C. or lower. For the Tg of the styrene-butadiene copolymer, differential scanning calorimetry (DSC) is performed at a rate of temperature increase of 20° C./minute to obtain a thermogram, and the temperature at the midpoint of the transition region is defined as the glass transition temperature. When the styrene-butadiene copolymer is an oil extended product, the Tg of the styrene-butadiene copolymer containing no oil-extending component (oil) is measured.

At least one terminal of the styrene-butadiene copolymer having a Tg of −55° C. or lower is preferably modified with a functional group. The modification of the styrene-butadiene copolymer having a Tg of −55° C. or lower can make the dispersibility of the silica good and further reduce the rolling resistance of the tire. Examples of the functional group include epoxy group, carboxy group, amino group, hydroxy group, alkoxy group, silyl group, alkoxysilyl group, amide group, oxysilyl group, silanol group, isocyanate group, isothiocyanate group, carbonyl group, and aldehyde group. Among them, a functional group having a polyorganosiloxane structure or an aminosilane structure is preferable. The presence of the functional group having the polyorganosiloxane structure or the aminosilane structure can make the dispersibility of the silica good and make the wet performance excellent.

The styrene content of the styrene-butadiene copolymer is not particularly limited and is preferably from 5 mass % to 30 mass %, and more preferably from 8 mass % to 25 mass %. The styrene content in this range is preferred because low rolling resistance of the tire can be achieved. The styrene content of the styrene-butadiene rubber can be measured by 1H-NMR.

The vinyl content of the styrene-butadiene copolymer is not particularly limited, and is preferably from 9 mol % to 45 mol %, more preferably from 20 mol % to 45 mol %, even more preferably from 25 mol % to 45 mol %, and particularly preferably from 28 mol % to 42 mol %. The vinyl content in this range is preferred because good dispersibility of the silica and low temperature dependency of rolling resistance can be achieved, and wear resistance can be ensured. The vinyl content of the styrene-butadiene rubber can be measured by 1H-NMR.

The styrene-butadiene copolymer may contain an oil-extending component. The oil extension amount of the styrene-butadiene copolymer is preferably 10 parts by mass or less per 100 parts by mass of the styrene-butadiene copolymer. The wear resistance can be effectively enhanced by setting the oil extension amount to 10 parts by mass or less. The oil extension amount is more preferably 8 parts by mass or less, and even more preferably 5 parts by mass or less.

The rubber composition for a tire according to an embodiment of the present technology contains 5 mass % or more of a butadiene copolymer in 100 mass % of the diene rubber, in addition to the styrene-butadiene copolymer described above. In addition to the performance described above, the snow performance can be improved by blending the butadiene copolymer. The content of the butadiene copolymer is 5 mass % or more, preferably 8 mass % or more, and more preferably 10 mass % or more, in 100 mass % of the diene rubber. The content of the butadiene copolymer is preferably 65 mass % or less, and more preferably 50 mass % or less, in 100 mass % of the diene rubber. When the content of the butadiene copolymer is less than 5 mass %, an effect of improving snow performance cannot be sufficiently obtained.

The rubber composition for a tire may contain another diene rubber besides the styrene-butadiene copolymer and the butadiene copolymer. Examples of the other diene rubber can include styrene-butadiene copolymer, natural rubber, isoprene rubber, butyl rubber, emulsion polymerized styrene-butadiene rubber, halogenated butyl rubber, acrylonitrile-butadiene rubber, and modified rubbers obtained by adding a functional group to these rubbers, each having a Tg of higher than −55° C. The other diene rubber may be used alone or as a discretionary blend. The content of the other diene rubber is preferably 40 mass % or less, more preferably from 0 mass % to 35 mass %, and even more preferably from 0 mass % to 25 mass % in 100 mass % of the diene rubber.

The rubber composition for a tire contains 30 parts by mass or more and less than 100 parts by mass of a white filler per 100 parts by mass of the diene rubber. Blending of the white filler can result in excellent wet performance and low rolling resistance. When the amount of the white filler is less than 30 parts by mass, wet performance and/or low rolling resistance become(s) unsatisfactory. When the amount of the white filler is 100 parts by mass or more, low rolling resistance deteriorates conversely. The white filler is preferably blended in an amount of 40 parts by mass or more and less than 100 parts by mass, and more preferably 45 parts by mass or more and less than 100 parts by mass.

Examples of the white filler are not particularly limited, and examples thereof include silica, calcium carbonate, magnesium carbonate, talc, clay, alumina, aluminum hydroxide, titanium oxide, and calcium sulfate. These can be used alone, or two or more thereof can be used in combination. Among them, silica is preferable, and the wet performance and the low heat build-up property can be made more excellent. As the silica, silica ordinarily used in a rubber composition for a tire is preferably used. For example, wet silica, dry silica, carbon-silica in which silica is carried on a carbon black surface (dual-phase filler), and silica that is surface-treated with a compound having reactivity or miscibility with both silica and rubber, such as a silane coupling agent or polysiloxane, can be used. Among these, a wet silica having hydrous silicic acid as a main component is preferred.

By blending another filler besides the white filler in the rubber composition for a tire, the strength of the rubber composition can be made high, and tire durability can be ensured. Examples of the other filler include an inorganic filler such as carbon black, mica, aluminum oxide, and barium sulfate; and an organic filler such as cellulose, lecithin, lignin, and dendrimer.

In particular, by blending the carbon black, excellent strength of the rubber composition can be achieved. As the carbon black, a carbon black such as furnace black, acetylene black, thermal black, channel black, and graphite can be blended. Of these, furnace black is preferred. Specific examples thereof include SAF (Super Abrasion Furnace), ISAF (Intermediate Super Abrasion Furnace), ISAF-HS (Intermediate Super Abrasion Furnace-High Structure), ISAF-LS (Intermediate Super Abrasion Furnace-Low Structure), IISAF-HS (Intermediate Intermediate Super Abrasion Furnace-High Structure), HAF (High Abrasion Furnace), HAF-HS (High Abrasion Furnace-High Structure), HAF-LS (High Abrasion Furnace-Low Structure), and FEF (Fast Extruding Furnace). One type of these carbon blacks may be used alone, or a combination of two or more types of these carbon blacks may be used. Furthermore, surface-treated carbon blacks, in which these carbon blacks are chemically modified with various acid compounds, can also be used.

When silica is used as the white filler, a silane coupling agent is preferably used in combination. By blending the silane coupling agent, the dispersibility of the silica in the diene rubber can be improved. The type of silane coupling agent is not particularly limited as long as it can be used in a rubber composition containing silica, and examples thereof include sulfur-containing silane coupling agents such as bis-(3-triethoxysilylpropyl) tetrasulfide, bis(3-triethoxysilylpropyl) disulfide, 3-trimethoxysilylpropylbenzothiazole tetrasulfide, γ-mercaptopropyltriethoxysilane, and 3-octanoylthiopropyltriethoxysilane. Among them, those having a tetrasulfide bond in the molecule can be particularly suitably used. The blended amount of the silane coupling agent is preferably from 3 mass % to 20 mass % and more preferably from 5 mass % to 15 mass % of the blended amount of the silica. When the blended amount of the silane coupling agent exceeds 20 mass % of the blended amount of the silica, the silane coupling agents condense with each other, and the desired hardness and strength of the rubber composition cannot be obtained.

When the rubber composition for a tire contains the specific thermoplastic resin, the temperature dependency of dynamic visco-elasticity can be adjusted. The specific thermoplastic resin is blended in an amount of 15 parts by mass or more and 80 parts by mass or less, preferably 20 parts by mass or more and 75 parts by mass or less, and more preferably 25 parts by mass or more and 60 parts by mass or less per 100 parts by mass of the diene rubber. When the amount of the thermoplastic resin is less than 15 parts by mass, the objects of the present technology, i.e., obtaining excellent wear resistance and wet performance and good low rolling resistance, and reducing temperature dependency of the rolling resistance, cannot be achieved. When the amount of the specific thermoplastic resin is more than 75 parts by mass, the wear resistance may deteriorate.

The specific thermoplastic resin satisfies the following relationship with the diene rubber. That is, a difference Tga-Tgm between Tga and Tgm is 10° C. or less, where Tga is a theoretical glass transition temperature of a mixture in which the diene rubber and the thermoplastic resin described above are blended at a mass ratio of 1:1, the theoretical glass transition temperature Tga being calculated from glass transition temperatures of the diene rubber and the thermoplastic resin, and Tgm is a measured glass transition temperature of the mixture. By having the difference Tga-Tgm be 10° C. or less, the wear resistance and the wet performance can be excellent, the rolling resistance can be reduced, and the temperature dependency thereof can be reduced. The difference Tga-Tgm is preferably 7° C. or less, and more preferably 5° C. or less. When the difference Tga-Tgm is 10° C. or less, it is considered that the diene rubber and the thermoplastic resin are in a compatible relationship, and that, by blending a relatively large amount of the thermoplastic resin, the tensile strength at break of the rubber composition is increased, which contributes to improvement in visco-elastic properties such as tan δ. In an embodiment of the present technology, the theoretical glass transition temperature (Tga) of the mixture can be calculated as a weighted average value based on the glass transition temperatures and the mass ratio of the diene rubber and the thermoplastic resin. The glass transition temperatures (Tg) of the diene rubber and the thermoplastic resin, and the glass transition temperature (Tgm) of the mixture, are measured values obtained by performing differential scanning calorimetry (DSC) at a rate of temperature increase of 20° C./min to obtain a thermogram and thereby obtain the temperature at the midpoint of the transition region as the glass transition temperatures Tg or Tgm. When there is a plurality of transition regions in the thermogram, the midpoint in the largest transition region is taken as the glass transition temperature Tgm of the mixture.

The thermoplastic resin is a resin usually blended in a rubber composition for a tire, has a molecular weight of about several hundreds to several thousands, and has a function of imparting adhesiveness to the rubber composition for a tire. The thermoplastic resin is preferably a resin composed of at least one selected from terpenes, modified terpenes, rosins, rosin esters, C5 components, and C9 components. Examples of the resin include natural resins such as terpene resins, modified terpene resins, rosin resins, and rosin ester resins; and synthetic resins such as petroleum resins including C5 components and C9 components, coal resins, phenol resins, and xylene resins.

Examples of the terpene resins include α-pinene resin, β-pinene resin, limonene resin, hydrogenated limonene resin, dipentene resin, terpene phenol resin, terpene styrene resin, aromatic modified terpene resin, and hydrogenated terpene resin. Examples of the rosin resins include modified rosins such as gum rosin, tall oil rosin, wood rosin, hydrogenated rosin, disproportionate rosin, polymerized rosin, maleated rosin, and fumarized rosin; ester derivatives of these rosins such as glycerine esters, pentaerythritol esters, methyl esters, and triethylene glycol esters; and rosin modified phenol resin.

Examples of the petroleum resin include aromatic hydrocarbon resins or, alternatively, saturated or unsaturated aliphatic hydrocarbon resins. Examples thereof include C5 petroleum resins (aliphatic petroleum resins formed by polymerizing fractions such as isoprene, 1,3-pentadiene, cyclopentadiene, methylbutene, pentene, and the like), C9 petroleum resins (aromatic petroleum resins formed by polymerizing fractions such as α-methylstyrene, o-vinyl toluene, m-vinyl toluene, p-vinyl toluene, and the like), C5C9 copolymerization petroleum resins, and the like.

The glass transition temperature (Tg) of the thermoplastic resin is preferably from 40° C. to 120° C., preferably from 45° C. to 115° C., and more preferably from 50° C. to 110° C. A Tg of the thermoplastic resin of 40° C. or higher can improve wet performance. A Tg of the thermoplastic resin of 120° C. or lower can improve wear resistance performance. The glass transition temperature of the thermoplastic resin can be measured by the method described above.

In the following description, the rubber composition for a tire of the present technology is referred to as rubber composition A, and a rubber composition having the same composition as that of the rubber composition A except that all the thermoplastic resin contained in the rubber composition A is replaced with oil is referred to as rubber composition B. A maximum value of a loss tangent at from −40° C. to 60° C. of the rubber composition A is defined as tan δ_{MAXA}, and a maximum value of a loss tangent at from −40° C. to 60° C. of the rubber composition B is defined as tan δ_{MAXB}. In this case, the tan δ_{MAXA} and the tan δ_{MAXB} preferably satisfy a relationship of Formula (1) below:

tan δ_{MAXA}/tan δ_{MAXB}>0.8 (1)

A ratio tan δ_{MAXA}/tan δ_{MAXB} between the maximum values of the loss tangents of more than 0.8 is preferred because the tensile strength at break of the rubber composition for a tire of the present technology (rubber composition A) becomes large, and the wear resistance when it is formed into a tire becomes more excellent. The rubber composition B tends to have high compatibility between the diene rubber and the oil contained therein and high tensile strength at break. When the tan δ_{MAXA} of the rubber composition A is close to the tan δ_{MAXB} of the rubber composition B, it is inferred that the visco-elastic behaviors of the rubber compositions are similar to each other, that the compatibility between the diene rubber and the thermoplastic resin is good, that the thermoplastic resin is prevented from becoming a starting point of breakage, and that the tensile strength at break is increased. The ratio tan δ_{MAXA}/tan δ_{MAXB} is more preferably more than 0.85 and even more preferably more than 0.9. In the present specification, the tan δ_{MAXA} and the tan δ_{MAXB} can be obtained by measuring the dynamic visco-elasticity of cured products of the rubber compositions A and B using a visco-elastic spectrometer under conditions of an elongation deformation strain rate of 10±2%, a vibration frequency of 20 Hz, and a temperature of from −40° C. to 60° C., obtaining a visco-elastic curve with the measurement temperature on the horizontal axis and the loss tangent (tan δ) on the vertical axis, and taking thickest values (peak values) of the tan δ as tan δ_{MAXA} and tan δ_{MAXB}, respectively.

The rubber composition for a tire according to an embodiment of the present technology may further contain oil. The blended amount of the oil is preferably less than 25 parts by mass, more preferably less than 10 parts by mass, and even more preferably 8 parts by mass per 100 parts by mass of the diene rubber. Suppressing the amount of the oil in this way is advantageous for maintaining good snow performance. When the blended amount of the oil is 25 parts by mass or more, the snow performance changes greatly over time, making it difficult to maintain good snow performance.

In addition to the components described above, the rubber composition for a tire may also contain various compounding agents that are commonly used in rubber compositions for a tire, in accordance with an ordinary method. Examples of the compounding agents include a vulcanization or crosslinking agent, a vulcanization accelerator, an anti-aging agent, a processing aid, a liquid polymer, and a thermosetting resin. These compounding agents can be kneaded by a common method to obtain a rubber composition that can then be used for vulcanization or crosslinking. These compounding agents can be compounded in known general amounts so long as the objects of the present technology are not hindered. The rubber composition for a tire can be prepared by mixing the above-mentioned components using a known rubber kneading machine such as a Banbury mixer, a kneader, or a roller.

The rubber composition for a tire is suitable for forming a tread portion or a side portion of a winter tire or an all-season tire assumed to run on snow-covered road surfaces, and especially suitable for forming a tread portion of the tires. The thus obtained winter tire and all-season tire can exhibit good snow performance, wet performance, and wear resistance performance.

Embodiments according to the present technology are further described below by Examples. However, the scope of the present technology is not limited to these Examples.

### Examples

For preparing 17 types of rubber compositions for a tire (Standard Example 1, Examples 1 to 8, and Comparative Examples 1 to 8) containing the common additive formulation listed in Table 3 and having the blend listed in Tables 1 and 2, components other than sulfur and vulcanization accelerators were weighed and kneaded in a 1.7 L sealed Banbury mixer for 5 minutes. Then, a master batch was discharged outside the mixer and cooled at room temperature. The master batch was placed in the Banbury mixer, and a sulfur and vulcanization accelerators were then added and mixed to obtain each of the rubber compositions for a tire. Regarding Comparative Example 8 in Table 1, SBR4 is an oil extended product having an oil extension amount of 25 parts by mass, and thus the blended amount without the oil-extending component is shown in parentheses in the lower part. The additive formulation in Table 3 is expressed as values in parts by mass per 100 parts by mass of the diene rubbers listed in Tables 1 and 2. Each of the rubber compositions for a tire of Examples 1 to 8 and Comparative Examples 1 to 8 described above is referred to as rubber composition A, and a rubber composition having the same composition as that of the rubber composition A except that all the thermoplastic resin contained in the rubber composition A was replaced with oil is referred to as rubber composition B. Furthermore, in a mixture in which the diene rubber and the thermoplastic resin constituting the rubber composition for a tire of each of the Examples and the Comparative Examples were blended at a mass ratio of 1:1, the glass transition temperature (Tgm) of the mixture was measured by the above-described method, the theoretical glass transition temperature Tga was calculated, and the difference Tga-Tgm of Tga from the measured glass transition temperature Tgm was calculated and shown in Tables 1 and 2. In addition, Tables 1 and 2 show the ratio tan δ_{MAXA}/tan δ_{MAXB} between the tan δ_{MAXA} of each rubber composition A and the tan δ_{MAXB} of each rubber composition B. The tan δ_{MAXA} and the tan δ_{MAXB} were determined by measuring the dynamic visco-elasticity of a cured product of each of the rubber compositions A and B using a visco-elastic spectrometer under conditions of an elongation deformation strain rate of 10±2%, a vibration frequency of 20 Hz, and a temperature of from −40° C. to 60° C., obtaining a visco-elastic curve with the measurement temperature on the horizontal axis and the loss tangent (tan δ) on the vertical axis, and taking thickest values (peak values) of the tan δ as tan δ_{MAXA} and tan δ_{MAXB}, respectively.

The rubber composition for a tire obtained as described above was vulcanized at 160° C. for 20 minutes in a mold having a predetermined form, and thus an evaluation sample was produced. Using the obtained evaluation sample, wear resistance, wet performance, and snow performance were measured by the following methods.

### Wear Resistance

Using a Lambourn abrasion test machine (available from Iwamoto Seisakusho K.K.), an amount of wear of the evaluation sample of the obtained rubber composition for a tire was measured in accordance with JIS (Japanese Industrial Standard) K6264 under the following conditions: a load of 15.0 kg (147.1 N) and a slip rate of 25%. A reciprocal for each of the obtained results was calculated, and shown in the rows of “wear resistance” in Tables 1 and 2 as an index value with a reciprocal of the amount of wear of Standard Example 1 being assigned the value of 100. A larger index value of wear resistance means superior wear resistance.

### Wet Performance

Pneumatic tires (test tires) having a tire size of 195/55R15 were produced using each of the above-described 17 types of rubber compositions for a tire (Standard Example 1, Comparative Examples 1 to 8, and Examples 1 to 8) in cap treads. The test tires were assembled to wheels having a rim size of 15 inches and mounted on a test vehicle with an air pressure of 230 kPa, and a braking distance from a running state at a speed of 40 km/h to a stop of the vehicle when ABS braking is performed was measured on a test course including a wet road surface. For the evaluation results, reciprocals of measured values were used and shown in the rows of “wet performance” in Tables 1 and 2 as index values with a reciprocal thereof of Standard Example 1 being assigned the value of 100. A larger index value means a shorter braking distance and superior wet performance.

### Snow Performance

Pneumatic tires (test tires) having a tire size of 195/55R15 were produced using each of the above-described 17 types of rubber compositions for a tire (Standard Example 1, Comparative Examples 1 to 8, and Examples 1 to 8) in cap treads. The test tires were assembled to wheels having a rim size of 15 inches and mounted on a test vehicle with an air pressure of 230 kPa, and a braking distance from a running state at a speed of 40 km/h to a stop of the vehicle when ABS braking is performed was measured on a test course including a compacted snow road. For the evaluation results, reciprocals of measured values were used and shown in the rows of “snow performance” in Tables 1 and 2 as index values with a reciprocal thereof of Standard Example 1 being assigned the value of 100. A larger index value means a shorter braking distance and superior snow performance.

TABLE 1

| | | Standard | Comparative | Comparative | Comparative | Comparative |
|---|---|---|---|---|---|---|
| | | Example 1 | Example 1 | Example 2 | Example 3 | Example 4 |
| NR | Parts by | | | | | |
| | mass | | | | | |
| SBR1 | Parts by | | 100 | 45 | 90 | 90 |
| | mass | | | | | |
| SBR2 | Parts by | 80 | | | | |
| | mass | | | | | |
| SBR3 | Parts by | | | | | |
| | mass | | | | | |
| SBR4 | Parts by | | | | | |
| | mass | | | | | |
| BR | Parts by | 20 | | 55 | 10 | 10 |
| | mass | | | | | |
| CB | Parts by | 10 | 10 | 10 | 10 | 10 |
| | mass | | | | | |
| Silica 1 | Parts by | 90 | 90 | 90 | 90 | 90 |
| | mass | | | | | |
| Silica 2 | Parts by | | | | | |
| | mass | | | | | |
| Silica 3 | Parts by | | | | | |
| | mass | | | | | |
| Resin 1 | Parts by | | 30 | 30 | | 90 |
| | mass | | | | | |
| Resin 2 | Parts by | | | | | |
| | mass | | | | | |
| Resin 3 | Parts by | | | | | |
| | mass | | | | | |
| Resin 4 | Parts by | | | | 30 | |
| | mass | | | | | |
| Silane | Parts by | 8 | 8 | 8 | 8 | 8 |
| coupling | mass | | | | | |
| agent 1 | | | | | | |
| Silane | Parts by | | | | | |
| coupling | mass | | | | | |
| agent 2 | | | | | | |
| Oil | Parts by | 35 | 5 | 5 | 5 | 5 |
| | mass | | | | | |
| Tga − Tgm | ° C. | — | 3 | 5 | 25 | 4 |
| tan δ_{MAXA}/ | | — | 0.87 | 0.85 | 0.51 | 0.67 |
| tan δ_{MAXB} | | | | | | |
| Wear | Index | 100 | 108 | 120 | 78 | 71 |
| resistance | value | | | | | |
| Wet | Index | 100 | 100 | 72 | 95 | 128 |
| performance | value | | | | | |
| Snow | Index | 100 | 94 | 125 | 113 | 65 |
| performance | value | | | | | |

| | | Comparative | Comparative | Comparative | Comparative |
|---|---|---|---|---|---|
| | | Example 5 | Example 6 | Example 7 | Example 8 |
| NR | Parts by | | | | |
| | mass | | | | |
| SBR1 | Parts by | 90 | 90 | | |
| | mass | | | | |
| SBR2 | Parts by | | | | |
| | mass | | | | |
| SBR3 | Parts by | | | 90 | |
| | mass | | | | |
| SBR4 | Parts by | | | | 112.5 |
| | mass | | | | (90) |
| BR | Parts by | 10 | 10 | 10 | 10 |
| | mass | | | | |
| CB | Parts by | 10 | 70 | 10 | 10 |
| | mass | | | | |
| Silica 1 | Parts by | 110 | 20 | 90 | 90 |
| | mass | | | | |
| Silica 2 | Parts by | | | | |
| | mass | | | | |
| Silica 3 | Parts by | | | | |
| | mass | | | | |
| Resin 1 | Parts by | 30 | 30 | 30 | 30 |
| | mass | | | | |
| Resin 2 | Parts by | | | | |
| | mass | | | | |
| Resin 3 | Parts by | | | | |
| | mass | | | | |
| Resin 4 | Parts by | | | | |
| | mass | | | | |
| Silane | Parts by | 9 | 2 | 8 | 8 |
| coupling | mass | | | | |
| agent 1 | | | | | |
| Silane | Parts by | | | | |
| coupling | mass | | | | |
| agent 2 | | | | | |
| Oil | Parts by | 5 | 5 | 5 | 5 |
| | mass | | | | |
| Tga − Tgm | ° C. | 4 | 4 | 6 | 6 |
| tan δ_{MAXA}/ | | 0.87 | 0.87 | 0.5 | 0.6 |
| tan δ_{MAXB} | | | | | |
| Wear | Index | 102 | 121 | 85 | 92 |
| resistance | value | | | | |
| Wet | Index | 105 | 72 | 105 | 112 |
| performance | value | | | | |
| Snow | Index | 92 | 110 | 71 | 88 |
| performance | value | | | | |

TABLE 2

| | | Example | Example | Example | Example | Example | Example | Example | Example |
|---|---|---|---|---|---|---|---|---|---|
| | | 1 | 2 | 3 | 4 | 5 | 6 | 7 | 8 |
| NR | Parts | | | | | | | | 10 |
| | by | | | | | | | | |
| | mass | | | | | | | | |
| SBR1 | Parts | 90 | 90 | 90 | 90 | 90 | 90 | 95 | 70 |
| | by | | | | | | | | |
| | mass | | | | | | | | |
| SBR2 | Parts | | | | | | | | |
| | by | | | | | | | | |
| | mass | | | | | | | | |
| SBR3 | Parts | | | | | | | | |
| | by | | | | | | | | |
| | mass | | | | | | | | |
| SBR4 | Parts | | | | | | | | |
| | by | | | | | | | | |
| | mass | | | | | | | | |
| BR | Parts | 10 | 10 | 10 | 10 | 10 | 10 | 5 | 20 |
| | by | | | | | | | | |
| | mass | | | | | | | | |
| CB | Parts | 10 | 10 | 10 | 10 | 10 | 10 | 10 | 10 |
| | by | | | | | | | | |
| | mass | | | | | | | | |
| Silica 1 | Parts | 90 | 90 | 90 | 70 | 70 | 90 | 90 | 90 |
| | by | | | | | | | | |
| | mass | | | | | | | | |
| Silica 2 | Parts | | | | 20 | | | | |
| | by | | | | | | | | |
| | mass | | | | | | | | |
| Silica 3 | Parts | | | | | 20 | | | |
| | by | | | | | | | | |
| | mass | | | | | | | | |
| Resin 1 | Parts | 30 | | | 30 | 30 | 30 | 45 | 30 |
| | by | | | | | | | | |
| | mass | | | | | | | | |
| Resin 2 | Parts | | 35 | | | | | | |
| | by | | | | | | | | |
| | mass | | | | | | | | |
| Resin 3 | Parts | | | 20 | | | | | |
| | by | | | | | | | | |
| | mass | | | | | | | | |
| Resin 4 | Parts | | | | | | | | |
| | by | | | | | | | | |
| | mass | | | | | | | | |
| Silane | Parts | 8 | 8 | 8 | 8 | 8 | | 8 | 8 |
| coupling | by | | | | | | | | |
| agent 1 | mass | | | | | | | | |
| Silane | Parts | | | | | | 6 | | |
| coupling | by | | | | | | | | |
| agent 2 | mass | | | | | | | | |
| Oil | Parts | 5 | | 15 | 5 | 5 | 5 | | 5 |
| | by | | | | | | | | |
| | mass | | | | | | | | |
| Tga − Tgm | ° C. | 4 | 3 | 5 | 4 | 4 | 4 | 3 | 5 |
| tan δ_{MAXA}/ | | 0.87 | 0.89 | 0.85 | 0.87 | 0.87 | 0.89 | 0.84 | 0.84 |
| tan δ_{MAXB} | | | | | | | | | |
| Wear | Index | 116 | 116 | 113 | 122 | 105 | 112 | 103 | 122 |
| resistance | value | | | | | | | | |
| Wet | Index | 103 | 103 | 105 | 103 | 101 | 105 | 124 | 101 |
| performance | value | | | | | | | | |
| Snow | Index | 112 | 112 | 107 | 113 | 120 | 115 | 112 | 115 |
| performance | value | | | | | | | | |

Types of raw materials used as indicated in Tables 1 and 2 are described below.
NR: Natural rubber; TSR 20 (glass transition temperature: −65° C.)
SBR1: Terminal-modified solution-polymerized styrene-butadiene rubber having a polyorganosiloxane structure; Nipol NS612, available from Zeon Corporation (glass transition temperature: −61° C.; styrene content: 15 mass %; vinyl content: 31 mol %; non-oil extended product)
SBR2: Terminal-modified solution-polymerized styrene-butadiene rubber having a polyorganosiloxane structure; Nipol NS616, available from Zeon Corporation (glass transition temperature: −23° C.; styrene content: 22 mass %; vinyl content: 67 mol %; non-oil extended product)
SBR3: Terminal-modified solution-polymerized styrene-butadiene rubber manufactured by batch polymerization; HPR850, available from JSR Corporation (glass transition temperature: −25° C.; styrene content: 27 mass %; vinyl content: 59 mol %; non-oil extended product)
SBR4: Alkoxysilane-modified solution-polymerized styrene-butadiene rubber manufactured by continuous polymerization; M2520, available from LG (glass transition temperature: −48° C.; styrene content: 27 mass %; vinyl content: 27 mol %; oil extension amount: 25 parts by mass)
BR: Butadiene rubber; Nipol BR1220, available from Zeon Corporation (glass transition temperature: −105° C.)
CB: Carbon black; SEAST 7HM, available from Tokai Carbon Co., Ltd.
Silica 1: Zeosil 1165MP, available from Solvey (nitrogen adsorption specific surface area: 159 m²/g)
Silica 2: ULTRASIL 9100GR, available from Evonik Industries AG (nitrogen adsorption specific surface area: 220 m²/g)
Silica 3: Zeosil 115GR, available from Solvey (nitrogen adsorption specific surface area: 110 m²/g)
Resin 1: Aromatic modified terpene resin; HSR-7, available from Yasuhara Chemical Co., Ltd. (glass transition temperature: 72° C.)
Resin 2: Aromatic modified terpene resin; YS resin TO-105, available from Yasuhara Chemical Co., Ltd. (glass transition temperature: 57° C.)
Resin 3: Indene resin; FMR0150, available from Mitsui Chemicals, Inc. (glass transition temperature: 89° C.)
Resin 4: Phenol-modified terpene resin; Tamanol 803L, available from Arakawa Chemical Industries, Ltd. (glass transition temperature: 95° C.)
Silane coupling agent 1: Sulfur-containing silane coupling agent; bis(3-triethoxysilylpropyl) tetrasulfide; Si69, available from Evonik Industries AG
Silane coupling agent 2:3-Octanoylthio-1-propyltriethoxysilane, NXT silane, available from Evonik Degussa
Oil: Extract 4S, available from Showa Shell Sekiyu K.K.

TABLE 3

| | | Blended |
|---|---|---|
| | | amount |
| Anti-aging agent | Parts by mass | 3 |
| Wax | Parts by mass | 1 |
| Sulfur | Parts by mass | 1.5 |
| Vulcanization | Parts by mass | 2 |
| accelerator | | |

Types of raw materials used as indicated in Table 3 are described below.
Anti-aging agent: VULANOX 4020, available from Lanxess AG
Wax: OZOACE-0015A, available from Nippon Seiro Co., Ltd.
Sulfur: SULFAX 5, available from Tsurumi Chemical Industry Co., Ltd.
Vulcanization accelerator: NOCCELER CZ-G, available from Ouchi Shinko Chemical Industrial Co., Ltd.

As is clear from Table 2, the rubber compositions for a tire of Examples 1 to 8 achieved excellent wear resistance, wet performance, and snow performance, which were improved in a well-balanced manner.

On the other hand, as is clear from Table 1, the rubber composition for a tire of Comparative Example 1 did not contain the butadiene rubber, and thus had deteriorated snow performance. The rubber composition for a tire of Comparative Example 2 contained a small blended amount of the styrene-butadiene rubber, and thus had deteriorated wet performance. The rubber composition for a tire of Comparative Example 3 had deteriorated wear resistance and wet performance, since the difference Tga-Tgm exceeded 10° C. The rubber composition for a tire of Comparative Example 4 had too large a resin amount, and thus had deteriorated wear resistance and snow performance. The rubber composition for a tire of Comparative Example 5 contained a large blended amount of silica, and thus had deteriorated snow performance. The rubber composition for a tire of Comparative Example 6 contained a small blended amount of silica, and thus had deteriorated wet performance. The rubber composition for a tire of Comparative Example 7 had deteriorated wear resistance and snow performance, since the styrene-butadiene rubber had a high glass transition temperature. The rubber composition for a tire of Comparative Example 8 had deteriorated wear resistance and snow performance, since the styrene-butadiene rubber had a high glass transition temperature.

1. A rubber composition for a tire, comprising:
100 parts by mass of a diene rubber comprising 55 mass % or more of a styrene-butadiene copolymer whose glass transition temperature is −55° C. or lower and 5 mass % or more of a butadiene copolymer;
30 parts by mass or more and less than 100 parts by mass of a white filler; and
15 parts by mass or more and 80 parts by mass or less of a thermoplastic resin,
the rubber composition for a tire satisfying a difference Tga-Tgm between Tga and Tgm of 10° C. or less,
where
Tga is a theoretical glass transition temperature of a mixture in which the diene rubber and the thermoplastic resin are blended at a mass ratio of 1:1, the theoretical glass transition temperature Tga being calculated from glass transition temperatures of the diene rubber and the thermoplastic resin, and
Tgm is a measured glass transition temperature of the mixture.

2. The rubber composition for a tire according to claim 1, wherein less than 25 parts by mass of oil is blended per 100 parts by mass of the diene rubber.

3. The rubber composition for a tire according to claim 1, wherein the styrene-butadiene copolymer has a glass transition temperature of −64° C. or lower.

4. The rubber composition for a tire according to claim 1, wherein at least one terminal of the styrene-butadiene copolymer is modified with a functional group.

5. The rubber composition for a tire according to claim 1, wherein the thermoplastic resin has a glass transition temperature of from 40° C. to 120° C.

6. The rubber composition for a tire according to claim 1, wherein the thermoplastic resin is at least one selected from the group consisting of resins composed of at least one selected from terpenes, modified terpenes, rosins, rosin esters, C5 components, and C9 components, and resins in which at least some of double bonds of these resins are hydrogenated.

7. The rubber composition for a tire according to claim 1, wherein an oil extension amount of the styrene-butadiene copolymer is 10 parts by mass or less per 100 parts by mass of the styrene-butadiene copolymer.

8. (canceled)

9. A tire comprising: a tread portion comprising the rubber composition for a tire according to claim 1.

10. The rubber composition for a tire according to claim 2, wherein the styrene-butadiene copolymer has a glass transition temperature of −64° C. or lower.

11. The rubber composition for a tire according to claim 10, wherein at least one terminal of the styrene-butadiene copolymer is modified with a functional group.

12. The rubber composition for a tire according to claim 11, wherein the thermoplastic resin has a glass transition temperature of from 40° C. to 120° C.

13. The rubber composition for a tire according to claim 12, wherein the thermoplastic resin is at least one selected from the group consisting of resins composed of at least one selected from terpenes, modified terpenes, rosins, rosin esters, C5 components, and C9 components, and resins in which at least some of double bonds of these resins are hydrogenated.

14. The rubber composition for a tire according to claim 13, wherein an oil extension amount of the styrene-butadiene copolymer is 10 parts by mass or less per 100 parts by mass of the styrene-butadiene copolymer.

15. The rubber composition for a tire according to claim 14, wherein a maximum value tan δ_{MAXA} of a loss tangent at from −40° C. to 60° C. of the rubber composition for a tire and a maximum value tan δ_{MAXB} of a loss tangent at from −40° C. to 60° C. of a rubber composition B having the same composition as that of the rubber composition for a tire except that all the thermoplastic resin is replaced with oil satisfy tan δ_{MAXA}/tan δ_{MAXB}>0.8 in relation to the rubber composition B.

16. A tire comprising: a tread portion comprising the rubber composition for a tire according to claim 15.

17. The rubber composition for a tire according to claim 1, wherein a maximum value tan δMAXA of a loss tangent at from −40° C. to 60° C. of the rubber composition for a tire and a maximum value tan δMAXB of a loss tangent at from −40° C. to 60° C. of a rubber composition B having the same composition as that of the rubber composition for a tire except that all the thermoplastic resin is replaced with oil satisfy tan δMAXA/tan δMAXB>0.8 in relation to the rubber composition B.
